(19) United States
(12) Patent Application Publication
(10) Pub. No.: US 2018/0248403 A1
(43) Pub. Date: Aug. 30, 2018

(54) POWER INFORMATION MANAGEMENT DEVICE, POWER INFORMATION MANAGEMENT SYSTEM, AND POWER INFORMATION MANAGEMENT METHOD

(71) Applicant: SHARP KABUSHIKI KAISHA, Sakai City, Osaka (JP)

(72) Inventors: KOICHI TAKASHITA, Sakai City (JP); YUSUKE YAMADA, Sakai City (JP); MISUZU KAWAMURA, Sakai City (JP)

(21) Appl. No.: 15/755,092

(22) PCT Filed: Aug. 3, 2016
(86) PCT No.: PCT/JP2016/072769

§ 371 Date: Feb. 26, 2018

(30) Foreign Application Priority Data
Aug. 31, 2015 (JP) 2015-170660

(51) Int. Cl. H02J 13/00; G05B 15/02; G06T 11/20

(52) U.S. Cl. CPC H02J 13/001; G06T 11/206; G05B 15/02

(57) ABSTRACT

A household electric appliance is operated with alternating current power. The household electric appliance is operated also with direct current power. A communication terminal displays a screen by execution of a power management application of a power management system including the household electric appliance. A graph of the screen indicates power consumption of each day for one month, more specifically, indicates consumption of direct current power supplied from a direct current power source to the household electric appliance together with consumption of alternating current power supplied from an alternating current power source thereto.

### TECHNICAL FIELD

This application claims the priority benefit of Japanese Patent Application No. 2015-170660 filed in Japan on Aug. 31, 2015, the contents of which is incorporated by reference herein in its entirety.

The present disclosure relates to provision of power information, and particularly relates to provision of information about power consumed by a load device that is operated with either alternating current power or direct current power.

### BACKGROUND ART

Conventionally, various HEMSs (Home Energy Management Systems), in which the amount of energy usage such as electricity or gas in a household electric appliance or an electric facility is displayed, have been proposed as energy saving measures. For example, Japanese Unexamined Patent Application Publication No. 11-248752 (PTL 1) proposes a device that displays, for a consumer, his or her daily power consumption and a current state of the power consumption with respect to a power-saving target value in real time in order to reduce power consumption.

### CITATION LIST

### Patent Literature

PTL 1: Japanese Unexamined Patent Application Publication No. 11-248752

PTL 2: Japanese Unexamined Patent Application Publication No. 2010-41784

### SUMMARY OF INVENTION

### Technical Problem

In conventional techniques, it is only assumed that energy saving is achieved by suppressing power consumption.

On the other hand, a technique in which energy saving is achieved by operating an appliance with direct current power has been recently proposed (refer to PTL 2). In a case where power is supplied with alternating current power to an appliance that is operated with direct current power, AC-DC conversion is performed, so that a power loss is caused by the conversion. Thus, operating the appliance with the direct current power without performing the AC-DC conversion is considered to exert an effect of reducing power consumption. In the conventional technique, however, there is no means to inform an effect of reduction in power consumption by operating an appliance with direct current power.

The disclosure was made in view of such circumstances and an object thereof is to provide a power information management device, a power information management system, and a power information management method that are able to inform an effect of reduction in power consumption by operating an appliance with direct current power.

### Solution to Problem

According to a certain aspect of the disclosure, provided is a power information management device that acquires information about power consumption of a load device that is operated by using alternating current power and direct current power as power, and generates display information about power consumption of the direct current power of the load device.

It is preferable that the display information includes display information about the power consumption of the direct current power of the load device, and includes information for displaying information about consumption of the alternating current power of the load device and the information about the consumption of the direct current power of the load device in different forms.

It is preferable that the display information includes first display information about the power consumption of the direct current power of the load device in a first period, and, second display information about the power consumption of the direct current power of the load device in each of second periods when the first period is divided into each of the second periods. The first display information is display information in which power consumption per first period is displayed distinctively in accordance with a proportions of the consumption of the direct current power and the consumption of the alternating current power. The second display information is display information in which, in each of the second periods, when the consumption of the direct current power occupies a certain proportion or more with respect to the power consumption of the second period, the power consumption of the second period is all regarded as the consumption of the direct current power.

It is preferable that the power information management device acquires operation time information indicating a time during which the load device is operated and switching information indicating, together with the time, with which of the alternating current power or the direct current power the load device is operated. In the operation time information, the power information management device specifies, as the consumption of the direct current power of the load device, consumption of power for a time during which the load device is operated with the direct current power in the switching information.

According to another aspect of the disclosure, provided is a power information management system, including: a direct current power source; a load device that is operated by using alternating current power and direct current power as power; and a power information management device that acquires information about power consumption of the load device, and generates display information about power consumption of the direct current power of the load device.

According to still another aspect of the disclosure, provided is a power information management method, including the steps of: acquiring information about power consumption of a load device that is operated by using alternating current power and direct current power as power and generating display information about power consumption of the direct current power of the load device.

According to still another aspect of the disclosure, provided is a power information management device. The power information management device acquires information about power consumption of a plurality of load devices including a load device that is operated with alternating current power and a load device that is operated with direct current power. The power information management device generates display information for displaying information about consumption of the alternating current power of the plurality of load devices and information about consumption of the direct current power of the plurality of load devices in different forms.

### Advantageous Effects of Invention

According to the disclosure, information about consumption of direct current power by operating an appliance with direct current power is displayed. This makes it possible for a user to easily recognize an effect of reduction in power consumption.

### BRIEF DESCRIPTION OF DRAWINGS

FIG. 1 illustrates a power management system according to a first embodiment.

FIG. 2 illustrates an example of display of power consumption of a household electric appliance in a communication terminal.

FIG. 3 is a block diagram illustrating a configuration of a HEMS controller.

FIG. 4 illustrates an example of a data structure of operation information stored in a storage unit of the HEMS controller.

FIG. 5 schematically illustrates an example of a sequence in which a record of operation execution is transmitted from each of household electric appliances to the HEMS controller.

FIG. 6 illustrates an example of a data structure of switching information stored in the storage unit of the HEMS controller.

FIG. 7 illustrates an example of a sequence in which an instruction of a power supply source is transmitted from a switching instruction transmission unit of the HEMS controller to each of the household electric appliances.

FIG. 8 schematically illustrates an example of a hardware structure of the household electric appliance.

FIG. 9 is a block diagram illustrating a configuration of a communication terminal of the first embodiment.

FIG. 10 is a flowchart of processing executed in the communication terminal to display information about consumption of direct current power in the household electric appliance.

FIG. 11 illustrates an example of a screen displayed by a power management application.

FIG. 12 illustrates another example of a screen displayed by the power management application.

FIG. 13 illustrates a modified example of a display screen of information about power consumption.

FIG. 14 illustrates an example of display related to power consumption of the household electric appliance in the second embodiment.

FIG. 15 is a block diagram illustrating a configuration of a communication terminal in a power management system of a third embodiment.

FIG. 16 illustrates an example of display of information about power consumption of the household electric appliance in the communication terminal of the third embodiment.

FIG. 17 is a flowchart of processing executed in the communication terminal of the third embodiment.

FIG. 18 is a flowchart of processing executed by a communication terminal in a fifth embodiment.

FIG. 19 is a block diagram illustrating a configuration of a HEMS controller of the fifth embodiment.

FIG. 20 is a flowchart of processing executed by a control unit of the HEMS controller of the fifth embodiment.

FIG. 21 schematically illustrates an example of content of power consumption information.

FIG. 22 illustrates a configuration of a HEMS controller of a sixth embodiment.

FIG. 23 is a block diagram illustrating a configuration of a communication terminal of the sixth embodiment.

### DESCRIPTION OF EMBODIMENTS

Hereinafter, embodiments of the disclosure will be described with reference to drawings. In the following description, the same elements have the same reference signs allotted. Their designation and function are also identical. Therefore, detailed description thereof will not be repeated.

### First Embodiment

### 1. Overview of Embodiment

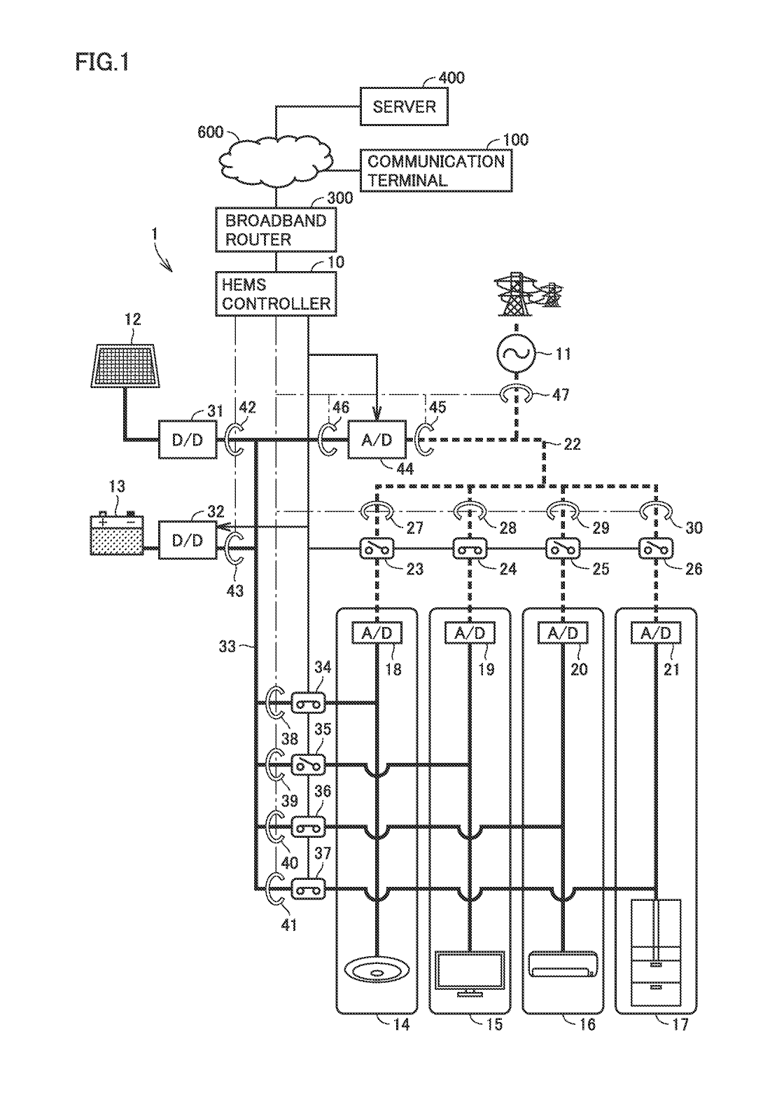

FIG. 1 illustrates a power management system 1 according to a first embodiment. The power management system 1 of FIG. 1 includes a HEMS (home energy management system) controller 10. The power management system 1 also includes a communication terminal 100 as an example of a power information management device. In FIG. 1, household electric appliances 14 to 17 are operated both with alternating current power from an alternating current power source 11 and with direct current power from a direct current power source 12 or 13. The household electric appliances 14 to 17 are controlled, for example by the HEMS controller 10, to use power from which power source to operate depending on a situation.

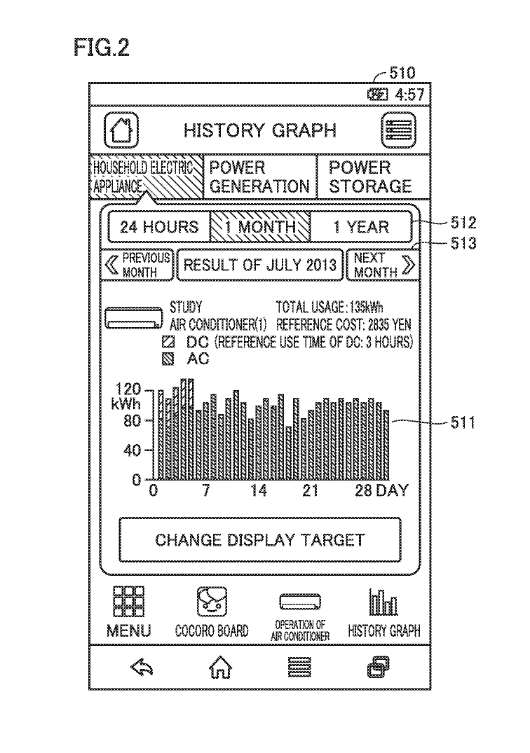

The communication terminal 100 has a touch panel 141 and a display 142 provided on a front side thereof. The communication terminal 100 displays, on the display 142, information about power consumption of the household electric appliances 14 to 17. FIG. 2 illustrates an example of display of power consumption of the household electric appliances 14 to 17 in the communication terminal 100.

As illustrated in FIG. 2, a screen 510 displayed in the communication terminal 100 includes a graph 511. The graph 511 indicates the power consumption of an appliance among the household electric appliances 14 to 17 during a certain month (1st to 30th of a certain month). A vertical axis of the graph 511 indicates consumption (kWh). The graph 511 is a bar graph including a plurality of bars and each of the bars indicates the power consumption of each day.

The graph 511 indicates the consumption of the alternating current power and the consumption of the direct current power in different forms. More specifically, five bars from a left end that indicate the consumption from the first day to the fifth day indicate the consumption of the alternating current power in lower parts thereof and indicate the consumption of the direct current power in upper parts thereof. Bars (the sixth bar from the left and bars positioned on the right side therefrom) corresponding to days subsequent to the sixth day do not include the consumption of the direct current power.

That is, the graph 511 indicates the consumption of the direct current power and the consumption of the alternating current power of each day in different forms.

Note that, a display target period as illustrated in FIG. 2 is able to be changed. The screen 510 includes an input unit 512 that is used to change a length of the display target period and an input unit 513 that is used to change the display target period.

The screen 510 also includes, as a “total usage”, a result (0.3 kWh) of the power consumption (direct current power and alternating current power) of a household electric appliance as a display target in the display target period. Further, the screen 510 includes, as a “reference cost”, when the consumption of the direct current power is exchanged with the consumption of the alternating current power, an estimated amount (2835 yen) for the resultant consumption of the household electric appliance of the display target, which is to be paid to a supply source (power company) of the alternating current power source 11.

### 2. Configuration of Power Management System

A configuration of the power management system 1 of FIG. 1 will be described.

As illustrated in FIG. 1, in the power management system 1, the HEMS controller 10 is able to be connected to a network 600 via a broadband router 300. The network 600 may be a public network such as the Internet or a private network such as an intra-company network. The HEMS controller 10 is able to communicate with the communication terminal 100 via the network 600.

The power management system 1 includes, as power sources, the alternating current power source 11 and the direct current power sources 12 and 13. The direct current power source 12 is, for example, a solar cell panel. The direct current power source 13 is, for example, a storage battery. In the storage battery of the direct current power source 13, a surplus of power generated by the solar cell panel of the direct current power source 12 and power fed from the alternating current power source 11 in a time zone, such as midnight, where a price of power is low, may be stored.

In the power management system 1, the four household electric appliances 14 to 17 serve as load devices. As the household electric appliances 14 to 17, any household electric appliances such as lighting equipment, a television receiver, an air conditioner, a washing machine, and a refrigerator are able to be applied. The number “four” of the household electric appliances in FIG. 1 is a simple example. In a case where the invention according to the present embodiment is carried out, the number of the household electric appliances may be four or more or less. The household electric appliances 14 to 17 are basically operated with the direct current power, but are able to be operated also with the alternating current power by having AC (alternating current)-DC (direct current) converters 18 to 21 embedded therein, respectively.

Supply of the alternating current power (hereinafter, referred to as “alternating current power supply”) is performed from the alternating current power source 11 to the household electric appliances 14 to 17 through an alternating current power supply path 22 indicated by the thick dotted line. In the alternating current power supply path 22, relays 23 to 26 are provided for the household electric appliances 14 to 17 on a one to one basis. The HEMS controller 10 controls the alternating current power supply for each of the household electric appliances 14 to 17 by opening or closing each of the relays 23 to 26. Current sensors 27 to 30 are arranged in the individual alternating current power supply path 22, in which the relays 23 to 26 are arranged, for the household electric appliances 14 to 17. Note that, electric parts of a different type may be used instead of the relays 23 to 26 as long as switching is able to be performed through communication from the HEMS controller 10. Any of wired communication (including power line communication) and wireless communication may be used to perform the communication. Similarly, any communication means may be used for the current sensors as long as a signal is able to be transmitted to the HEMS controller 10.

A DC-DC converter 31 is connected to a path in which power is output from the direct current power source 12. A DC-DC converter 32 is connected to a path in which power is output from the direct current power source 13. Supply of the direct current power (hereinafter, referred to as “direct current power supply”) is performed from the DC-DC converters 31 and 32 to the household electric appliances 14 to 17 through a direct current power supply path 33 indicated by the thick solid line. In the direct current power supply path 33, relays 34 to 37 are provided for the household electric appliances 14 to 17 on a one to one basis. The HEMS controller 10 controls the direct current power supply for each of the household electric appliances 14 to 17 by opening or closing each of the relays 34 to 37. Current sensors 38 to 41 are arranged in the individual direct current power supply path 33, in which the relays 34 to 37 are arranged, for the household electric appliances 14 to 17. Current sensors 42 and 43 are provided also in a path in which each of the DC-DC converters 31 and 32 outputs power.

The alternating current power supply path 22 and the direct current power supply path 33 are connected to each other via an AC-DC converter 44 that is a system interconnection inverter. A current sensor 45 is arranged at a part where the AC-DC converter 44 is connected to the alternating current power supply path 22 and a current sensor 46 is arranged at a part where the AC-DC converter 44 is connected to the direct current power supply path 33. A current sensor 47 is arranged at a part nearest to the alternating current power source 11 in the alternating current power supply path 22.

In FIG. 1, command transmission systems from the HEMS controller 10 to the relays 23 to 26, the relays 34 to 37, and the AC-DC converter 44 are indicated by the thin solid line. Signal transmission systems from the current sensors 27 to 30, 38 to 41, 42, 43, 45, 46, and 47 to the HEMS controller 10 are indicated by the thin one dot chain line.

### 3. Configuration of HEMS Controller

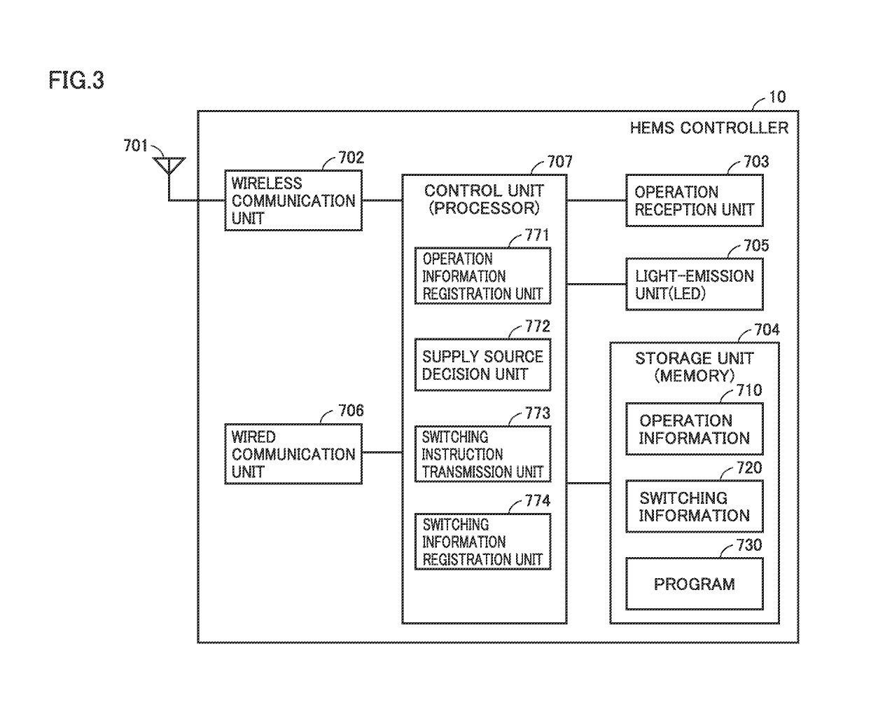

FIG. 3 is a block diagram illustrating a configuration of the HEMS controller 10.

With reference to FIG. 3, the HEMS controller 10 includes an antenna 701, a wireless communication unit 702, an operation reception unit 703, a storage unit 704, a light-emission unit 705, a wired communication unit 706, and a control unit 707.

The antenna 701 emits a signal, which is output from the HEMS controller 10, in a form of a radio wave. The antenna 701 receives the radio wave from a space and provides the wireless communication unit 702 with a received signal.

The wireless communication unit 702 is a communication interface that performs modulation and demodulation processing or the like for transmitting and receiving a signal in order for the HEMS controller 10 to perform wireless communication with another communication device.

The HEMS controller 10 conforms to, for example, a wireless LAN (Local Area Network) standard or a standard of near field communication such as Bluetooth (registered trademark), and communicates with the household electric appliances 14 to 17 (refer to FIG. 1) in accordance with such a communication standard. The HEMS controller 10 and each of the household electric appliances 14 to 17 conform to a standard for performing a remote operation of the household electric appliance.

By communicating with each of the household electric appliances 14 to 17, the HEMS controller 10 is able to receive information indicating that each of the household electric appliances 14 to 17 is in operation. In a case where a time to start an operation of each of the household electric appliances 14 to 17 is reserved, the HEMS controller 10 receives, from each of the household electric appliances 14 to 17, information about a time zone in which the operation is to be performed. In addition, by communicating with the household electric appliances 14 to 17, the HEMS controller 10 transmits an instruction to restrict at least a part of the operation to the household electric appliances 14 to 17. Each of the household electric appliances 14 to 17 communicates with the HEMS controller 10 and stops or executes a function in accordance with the instruction from the HEMS controller 10.

The operation reception unit 703 is constituted by an operation member, for example, such as a button for receiving an input operation, and receives an input operation of a user and outputs the received input operation to the control unit 707.

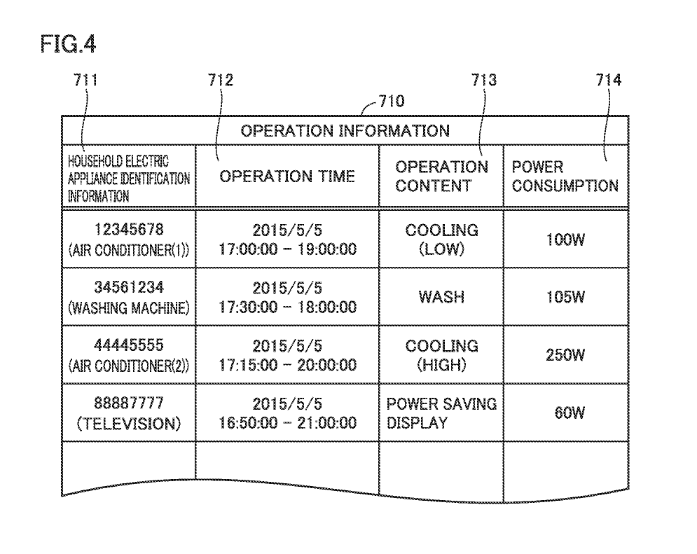

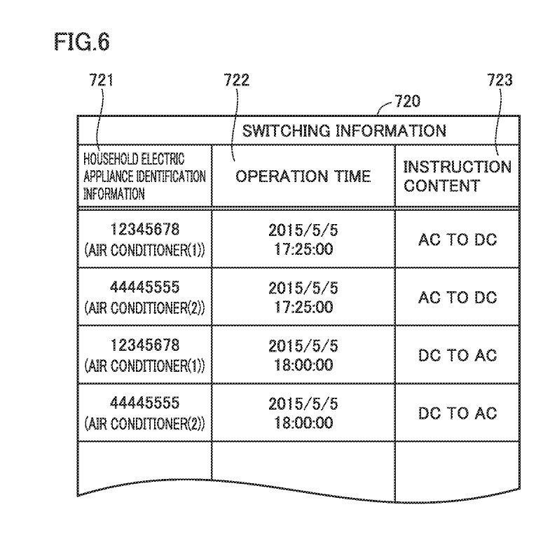

The storage unit 704 is constituted by a flash memory, a RAM, or the like, and stores a program and data that are used by the HEMS controller 10. In a certain aspect, the storage unit 704 stores operation information 710, switching information 720, and a program 730. The operation information 710 is information indicating operations of the household electric appliances 14 to 17 and an example thereof will be described later with reference to FIG. 4. The switching information 720 is information for giving an instruction about whether to drive each of the household electric appliances 14 to 17 with the alternating current power or the direct current power, and an example thereof will be described later with reference to FIG. 6. The program 730 is a program executed by the control unit 707, for example.

The light-emission unit 705 includes a light-emission member such as an LED (Light Emitting Diode). The light-emission unit 705 emits light under control of the control unit 707 to thereby notify the outside of the HEMS controller 10 of information. The HEMS controller 10 causes the light-emission unit 705 to emit light to thereby notify the outside, for example, that the HEMS controller 10 is in communication or that power failure occurs in a system.

The wired communication unit 706 is a communication interface that performs modulation and demodulation processing or the like in order for the HEMS controller 10 to perform communication with another communication device in a wired manner. The wired communication unit 706 is able to be connected to the broadband router 300 (refer to FIG. 1).

The control unit 707 is constituted by a processor and controls an operation of the HEMS controller 10 by reading and executing a control program stored in the storage unit 704. The control unit 707 is operated in accordance with the program to thereby implement functions as an operation information registration unit 771, a supply source decision unit 772, a switching instruction transmission unit 773, and a switching information registration unit 774.

The operation information registration unit 771 acquires information about the operation of each of the household electric appliances 14 to 17 from each of the household electric appliances 14 to 17 and registers the information in the storage unit 704 as operation information.

The supply source decision unit 772 decides a power supply source (the direct current power source 12 or 13 or the alternating current power source 11) of each of the household electric appliances 14 to 17. The supply source decision unit 772 decides the direct current power source 12 or 13 as the power supply source, for example, during the daytime in which a price of the alternating current power from the alternating current power source 11 is high. Moreover, the supply source decision unit 772 decides the alternating current power source 11 as the power supply source when a power generation amount of the direct current power source 12 is small, for example, on a rainy day and a remaining battery level of the direct current power source 13 is low.

The switching instruction transmission unit 773 instructs each of the relays 23 to 26 and the relays 27 to 30 to open or close a circuit so that the power supply source of each of the household electric appliances 14 to 17 is the power supply source decided by the supply source decision unit 772.

Note that, in a case where the relays 23 to 26 and the relays 27 and 30 are respectively provided in the household electric appliances 14 to 17, the switching instruction transmission unit 773 transmits an instruction of the power supply source to each of the household electric appliances 14 to 17. In accordance with the instruction, each of the household electric appliances 14 to 17 switches open and close of (any of the relays 23 to 26 and any of the relays 27 to 30) in each of the appliances and adjusts the power supply source with respect to each of the appliances.

The switching information registration unit 774 registers the power supply source of each of the household electric appliances 14 to 17, which is decided by the supply source decision unit 772, in the storage unit 704 as switching information.

### 4. Operation Information

FIG. 4 illustrates an example of a data structure of the operation information 710 stored in the storage unit 704 of the HEMS controller 10.

As illustrated in FIG. 4, in each of records in the operation information 710, household electric appliance identification information 711, an operation time 712, operation content 713, and power consumption 714 are associated with each other. Each of the records is transmitted, for example, from each of the household electric appliances 14 to 17 (refer to FIG. 1). Each of the household electric appliances 14 to 17 transmits a record of operation execution to the HEMS controller 10. Upon reception of the record, the operation information registration unit 771 (refer to FIG. 3) of the HEMS controller 10 updates the operation information 710 by adding the record.

The household electric appliance identification information 711 is information for specifying each of the household electric appliances 14 to 17. For example, “12345678 (air conditioner (1))” in FIG. 4 specifies one air conditioner among the household electric appliances 14 to 17.

The operation time 712 indicates a time at which a household electric appliance was operated. For example, “2015/5/5_17:00:00-19:00:00” in FIG. 4 indicates that the household electric appliance was operated from 17:00:00 to 19:00:00 on May 5, 2015.

The operation content 713 indicates what operation was executed by the household electric appliance. For example, “cooling (low)” in FIG. 4 indicates that a cooling operation with intensity “low” was executed.

The power consumption 714 indicates the power consumption in the household electric appliance indicating the operation content specified by the operation content 713. For example, “100 W” registered correspondingly to the operation content of “cooling (low)” in FIG. 4 indicates that the power consumption of the cooling operation with the intensity “low” is 100 W.

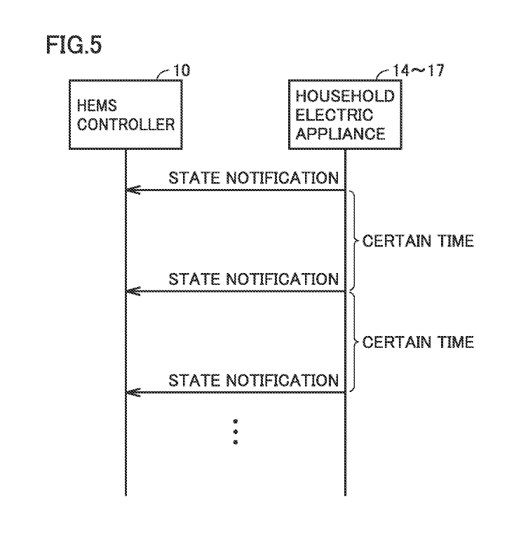

FIG. 5 schematically illustrates an example of a sequence in which a record of operation execution is transmitted from each of the household electric appliances 14 to 17 to the HEMS controller 10. As illustrated in FIG. 5, each of the household electric appliances 14 to 17 executes “state notification” to the HEMS controller 10 at a certain time interval (for example, per 15 minutes). The “state notification” is a view indicating what content of operation was executed. There is also a case where “state notification” is information indicating that an operation in execution was finished.

Upon reception of the “state notification” from each of the household electric appliances 14 to 17, on the basis of information thereof, the operation information registration unit 771 (refer to FIG. 3) of the HEMS controller 10 generates a record for each of the household electric appliances illustrated in FIG. 4. For example, in accordance with receiving, as the “state notification”, from the household electric appliance specified by “12345678 (air conditioner (1))”, information indicating that an operation specified by “cooling (low)” was executed from 17:00:00 to 19:00:00 on May 5, 2015 and that the operation was finished at 19:00:00 on May 5, 2015, the operation information registration unit 771 generates a record related to “12345678 (air conditioner (1))” as illustrated in FIG. 4.

### 5. Switching Information

FIG. 6 illustrates an example of a data structure of the switching information 720 stored in the storage unit 704 of the HEMS controller 10.

As illustrated in FIG. 6, in each of records in the switching information 720, household electric appliance identification information 721, a time 722, and instruction content 723 are associated with each other.

The household electric appliance identification information 721 specifies any of the household electric appliances 14 to 17. The time 722 indicates a time at which information for designating the power supply source to the household electric appliance specified by the household electric appliance identification information 721 was output. The instruction content 723 indicates the designated power supply source.

For example, “AC to DC” indicates that the designated power supply source is the direct current power source 12 or the direct current power source 13. “DC to AC” indicates that the designated power supply source is the alternating current power source 11.

When setting (switching) the supply source of the power to be used as power for each of the household electric appliances 14 to 17, the switching instruction transmission unit 773 (refer to FIG. 3) of the HEMS controller 10 instructs a corresponding relay of the relays 23 to 26 and the relays 34 to 37 to switch open and close, and gives an instruction to each of the household electric appliances 14 to 17. When driving with the alternating current power, the household electric appliances 14 to 17 respectively drive the AC-DC converters 18 to 21.

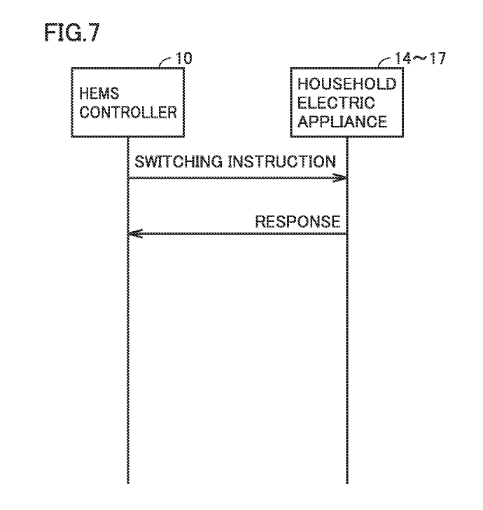

FIG. 7 illustrates an example of a sequence in which an instruction of a power supply source is transmitted from the switching instruction transmission unit 773 (refer to FIG. 3) of the HEMS controller 10 to each of the household electric appliances 14 to 17. As illustrated in FIG. 7, the HEMS controller 10 (switching instruction transmission unit 773) transmits an instruction to set (switch) the supply source as a “switching instruction”. Upon reception of the instruction to set (switch) the supply source, each of the household electric appliances 14 to 17 transmits a “response” to the HEMS controller 10. In accordance with transmitting the “switching instruction” to the household electric appliance and receiving the “response” from the corresponding household electric appliance, the switching information registration unit 774 generates a new record and adds the record to the switching information 720.

### 6. Configuration of Household Electric Appliance

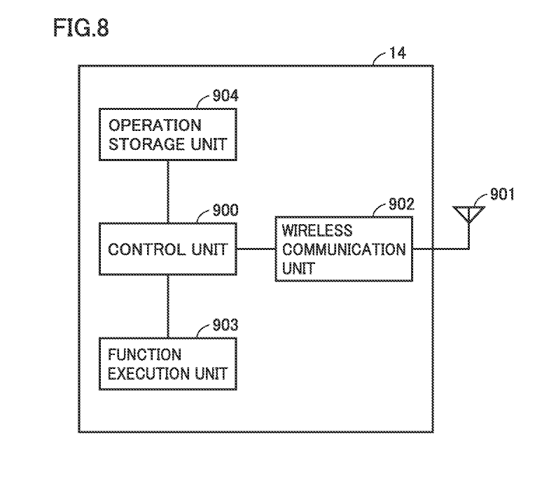

FIG. 8 schematically illustrates an example of a hardware configuration of the household electric appliance 14. As illustrated in FIG. 8, the household electric appliance 14 includes a control unit 900, an antenna 901, a wireless communication unit 902, a function execution unit 903, and an operation storage unit 904.

The control unit 900 is, for example, a processor and controls an operation of the household electric appliance 14 by executing a program stored in a memory in a memory (not illustrated) inside the household electric appliance 14.

The antenna 901 is used for communication with another device such as the HEMS controller 10.

The wireless communication unit 902 is an example of a communication interface. The control unit 900 is connected to the network 600 (refer to FIG. 1) by using the wireless communication unit 902 and the antenna 901 and communicates with another device such as the HEMS controller 10. Note that, the household electric appliance 14 may conform to a wireless LAN standard or a standard of near field communication such as Bluetooth (registered trademark) in some cases. In accordance with such a communication standard, the household electric appliance 14 may directly communicate with another device such as the HEMS controller 10 in some cases.

The function execution unit 903 executes an inherent function of the household electric appliance 14. In a case of lighting equipment, the function execution unit 903 is, for example, an element that implements a function for causing a light-emission element to light up. In a case of an air conditioner, the function execution unit 903 is, for example, an element, such as a compressor and a control circuit thereof, that implements a function for cooling an article.

The operation storage unit 904 is a memory and stores content of an operation executed by the function execution unit 903. For example, at timing when causing the function execution unit 903 to start an operation indicating new content, the control unit 900 causes the content to be stored in the operation storage unit 904. The control unit 900 transmits the operation content, which is stored in the operation storage unit 904, to the HEMS controller 10 as the “state notification” (refer to FIG. 5).

Schematic configurations of the household electric appliances 15 to 17 may be similar to the configuration of the household electric appliance 14 illustrated in FIG. 8.

### 7. Configuration of Communication Terminal

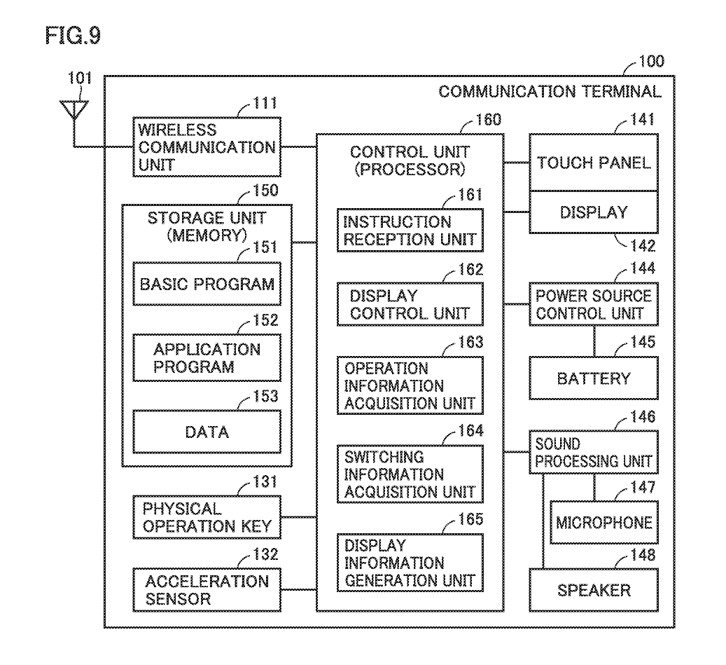

FIG. 9 is a block diagram illustrating a configuration of the communication terminal 100 of the first embodiment.

As illustrated in FIG. 9, the communication terminal 100 includes an antenna 101, a wireless communication unit 111, a physical operation key 131, a touch panel 141, a display 142, a power source control unit 144, a battery 145, a sound processing unit 146, a microphone 147, a speaker 148, a storage unit 150, and a control unit 160.

The antenna 101 emits a signal, which is output from the communication terminal 100, in a form of a radio wave. The antenna 101 receives the radio wave from a space and provides the wireless communication unit 111 with a received signal. In the present embodiment, the communication terminal 100 conforms to a plurality of wireless communication standards. As a communication scheme, there are W-CDMA (Wideband Code Division Multiple Access), LTE (Long Term Evolution), and other communication schemes. The communication terminal 100 conforms also to a wireless LAN standard such as IEEE (Institute of Electrical and Electronic Engineers) 802.11.

The wireless communication unit 111 performs modulation and demodulation processing or the like for transmitting and receiving a signal via the antenna 101 or the like in order for the communication terminal 100 to communicate with another wireless device. The wireless communication unit 111 is a communication module that includes a tuner, an RSSI (Received Signal Strength Indicator) calculation circuit, a CRC (Cyclic Redundancy Check) calculation circuit, a high frequency circuit, and the like. The wireless communication unit 111 performs modulation and demodulation or frequency conversion for a wireless signal transmitted or received by the communication terminal 100 and provides the control unit 160 with a received signal.

The physical operation key 131 is a physical input device and receives a pressing operation by the user. In response to the pressing operation by the user, the physical operation key 131 outputs a signal indicating operation content to the control unit 160.

The storage unit 150 is constituted by, for example, a flash memory or the like, and stores data and a program that are used by the communication terminal 100. In a certain aspect, the storage unit 150 stores a basic program 151, an application program 152, and data 153. The basic program 151 is a program that is executed for the communication terminal 100 to implement a call function or the like. The application program 152 is a program that is executed for the communication terminal 100 to implement an additional operation. The additional operation includes display of information about the power consumption of a household electric appliance as illustrated in FIG. 2. The data 153 is various data that is used to execute a program in the communication terminal 100.

The power source control unit 144 controls power supply to each circuit of the communication terminal 100. The power source control unit 144 is, for example, an IC (Integrated Circuit) for power source control. The battery 145 is a supply source that supplies power to operate each circuit of the communication terminal 100. The power from the battery 145 is supplied to each circuit under control of the power source control unit 144. The sound processing unit 146 performs modulation and demodulation of a sound signal. The sound processing unit 146 modulates a signal given from the microphone 147 and provides the control unit 160 with a modulated signal. The sound processing unit 146 provides the speaker 148 with the sound signal. The sound processing unit 146 is realized by, for example, a processor for sound processing. The microphone 147 receives a sound input and provides the sound processing unit 146 with a sound signal corresponding to the sound input. The speaker 148 converts the sound signal provided from the sound processing unit 146 into sound and outputs the sound to the outside of the communication terminal 100.

The control unit 160 reads a program stored in the storage unit 150 and executes a command included in the control program to thereby control an operation of the communication terminal 100. The control unit 160 is, for example, a processor. Being operated in accordance with the program, the control unit 160 implements functions as an instruction reception unit 161, a display control unit 162, an operation information acquisition unit 163, and a switching information acquisition unit 164.

The instruction reception unit 161 receives an input for giving an instruction to display information about the power of the household electric appliance. The instruction may be an operation instruction with respect to the touch panel 141, an instruction by a sound input with respect to the microphone 147, or an operation instruction generated when a specific application program is executed.

The display control unit 162 is realized by, for example, the control unit 160 that executes a driver program of the display 142 and controls a display operation of the display 142.

The operation information acquisition unit 163 acquires, from the HEMS controller 10, operation information (refer to FIG. 4) of an appliance whose information about the power is to be displayed among the household electric appliances 14 to 17.

The switching information acquisition unit 164 acquires, from the HEMS controller 10, switching information (refer to FIG. 6) of the appliance whose information about the power is to be displayed among the household electric appliances 14 to 17.

### 8. Display Processing

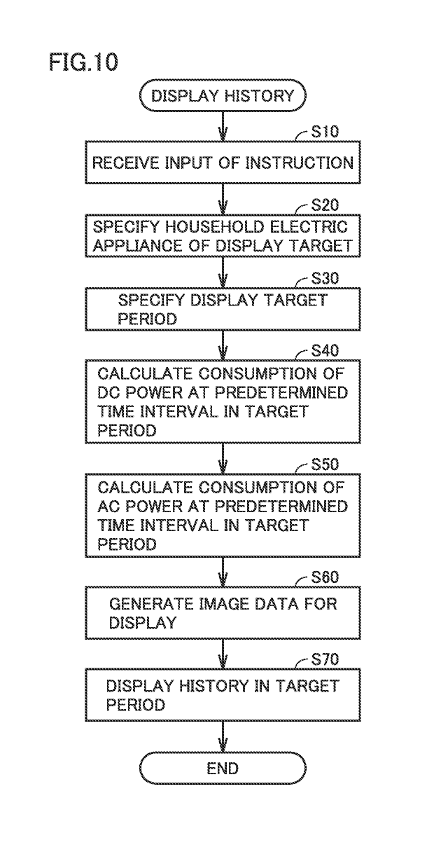

FIG. 10 is a flowchart of processing executed in the communication terminal 100 to display information about consumption of the direct current power in each of the household electric appliances 14 to 17. The processing is realized by, for example, a power management application installed on the communication terminal 100.

With reference to FIG. 10, at step S10, the control unit 160 (refer to FIG. 9) of the communication terminal 100 receives an input for giving an instruction to present information about the power consumption of a household electric appliance. In an example, the instruction is input by an operation instruction with respect to the touch panel 141. In another example, the instruction is input by sound with respect to the microphone 147. In still another example, the instruction is input by an operation input generated by execution of a specific application program (for example, a timer function to display information about the power of the household electric appliance at 8:00 a.m. on the first day of every month). Then, the control is caused to proceed to step S20.

At step S20, the control unit 160 specifies a household electric appliance of a display target. Then, the control is caused to proceed to step S30.

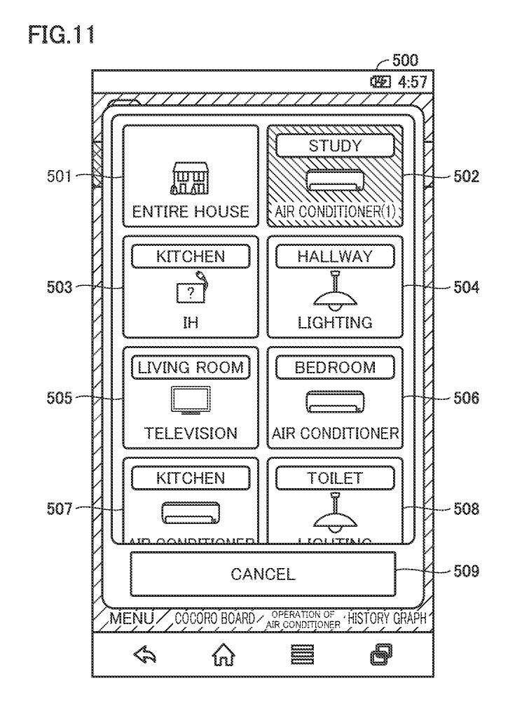

Note that, in an example of step S20, the control unit 160 reads out information which is stored in the storage unit 150 in advance and specifies the household electric appliance of the display target. In another example, the control unit 160 receives an input of an instruction to specify the household electric appliance of the display target. An example of the input of the instruction will be described with reference to FIG. 11.

FIG. 11 illustrates an example of a screen displayed on the display 142 by the power management application. A screen 500 of FIG. 11 is displayed to select an appliance having a display form of information about power.

The screen 500 includes buttons 501 to 508 for selecting the household electric appliance of the display target. Each of the buttons 502 to 508 corresponds to selection of each of household electric appliances (each of the household electric appliances 14 to 17 in the example indicated in FIG. 1) that constitute the power management system 1. The button 501 corresponds to all the household electric appliances that constitute the power management system 1. The control unit 160 specifies the household electric appliance of the display target in accordance with which button in the screen 500 is pressed.

With reference back to FIG. 10, the control unit 160 specifies a display target period at step S30. Then, the control is caused to proceed to step S40.

Note that, an example of the period specified at step S30 is 1 month. Another example thereof is 1 year. Still another example thereof is 1 day. Still another example is a period till when step S30 is executed after recording of data associated with the power consumption of a household electric appliance starts in the HEMS controller 10.

Alternatively, at step S30, the control unit 160 specifies the display target period, for example, in accordance with a touch operation with respect to the touch panel 141. More specifically, for example, when the household electric appliance of the display target is specified on the screen 500 of FIG. 11, the screen 510 (refer to FIG. 2) is displayed on the display 142. “Result of July 2013” is described in the center of the input unit 513 of the screen 510. This means that the display target is July 2013. When a “previous month” button on a left end in the input unit 513 is touched, the control unit 160 specifies the previous month of July 2013, that is, June 2013 as the display target. When a “next month” button on a right end in the input unit 513 is touched, the control unit 160 specifies a next month of July 2013, that is, August 2013 as the display target.

In addition, at step S30, the control unit 160 specifies a length of the display target period, for example, in accordance with a touch operation with respect to the touch panel 141. More specifically, in accordance with any of three buttons “24 hours”, “1 month”, and “1 year” in the input unit 512 of the screen 510 of FIG. 2 being touched, the control unit 160 specifies, as the length of the display target period, a period described in each of the buttons.

Note that, at step S30, there may be a case where the control unit 160 specifies the length of the display target period in accordance with data stored in the storage unit 150 or a period specified by another application being executed in the communication terminal 100.

With reference back to FIG. 10, the control unit 160 calculates the consumption of the direct current power (DC power) of the target household electric appliance in the target period at step S40. Then, the control is caused to proceed to step S50.

Note that, at step S40, the target household electric appliance has been specified at step S20. The target period has been specified at step S30. The control unit 160 acquires operation information and switching information of the target appliance from the HEMS controller 10. Then, on the basis of the switching information, the control unit 160 specifies an operation period with the direct current power in the target period. On the basis of the operation information, the control unit 160 specifies operation content in the specified operation period. The control unit 160 calculates an amount of power, which is required to perform an operation of the specified content, in the specified operation period. Then, the control unit 160 specifies the calculated amount of power as the consumption of the direct current power of the target household electric appliance in the target period. Here, the consumption in the target period is specified per certain period in the target period. For example, the consumption of 1 month is displayed day by day on the screen 510 of FIG. 2. In this manner, the consumption in a predetermined period (for example, 1 month) is calculated per certain period (for example, 1 day).

With reference back to FIG. 10, the control unit 160 calculates the consumption of the alternating current power (AC power) of the target household electric appliance in the target period at step S50. Then, the control is caused to proceed to step S60.

Note that, at step S50, the control unit 160 calculates, per certain period, the consumption of the alternating current power of the household electric appliance of the display target in the display target period by using the operation information and the switching information that are acquired at step S40.

At step S60, by using the consumption of the direct current power, which is calculated at each of step S40 and S50, the control unit 160 generates image data for display that is related to information about the power consumption as in the screen 510 of FIG. 2. Here, as indicated with the graph 511, for a predetermined period (1 month) as the display target, the consumption of each of the direct current power and the alternating current power of the household electric appliance of the display target is displayed per certain period (1 day). Then, the control is caused to proceed to step S70.

Note that, the generation of the image data for display at step S60 includes calculation of numerical values corresponding to the “total usage” and the “reference cost” of the screen 510 of FIG. 2. The “total usage” is a total value of the consumption of the direct current power and the alternating current power. The “reference cost” is a product of the consumption of the direct current power and a predefined unit cost for purchasing the alternating current power.

At step S70, the control unit 160 displays the image data generated at step S60 (displays a history of the target period) on the display, and ends the processing of FIG. 10.

### 9. Example of Another Display Screen

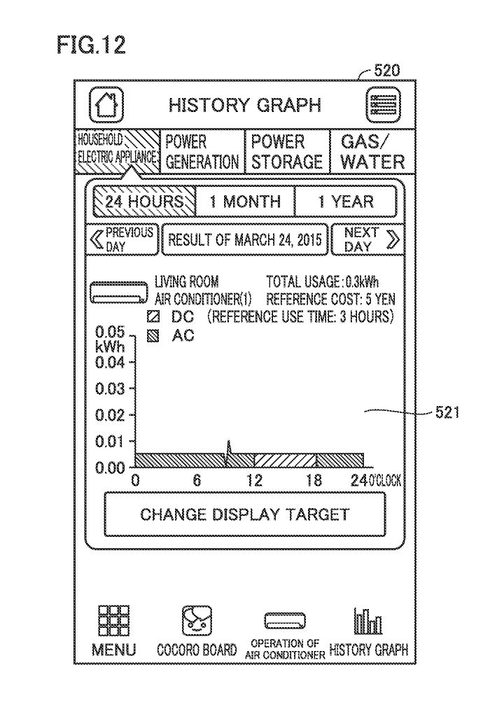

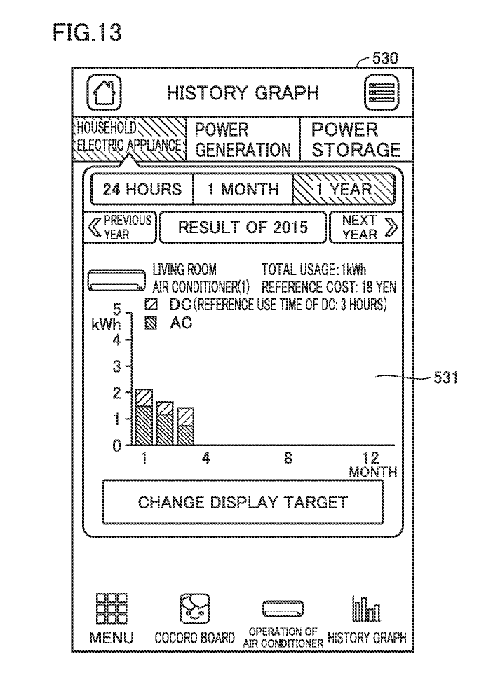

FIGS. 12 and 13 are views each illustrating a modified example of a display screen for information about the power consumption. A screen 520 of FIG. 12 corresponds to a case where the predetermined period (display target period) is 24 hours. The screen 520 includes a graph 521. In the graph 521, a color of the graph is specified per certain period (15 minutes). In the graph 521, a vertical axis indicates power consumption and a horizontal axis indicates a time. The certain period may be set as a time that is the same as a time interval at which each of the household electric appliances 14 to 17 transmits the “state notification” (refer to FIG. 5) to the HEMS controller 10 or that is obtained by adding a slight margin to the time interval.

In FIG. 12, the color of the graph is represented on the basis of a type of hatching. In each of 15-minute periods, when the direct current power has been used for a certain period (for example, 5 minutes) or more in the 15-minute period, the period is indicated in such a manner that the direct current power has been used for the full 15 minutes. That is, the graph 521 of FIG. 12 is displayed by deforming the consumption of the direct current power.

A screen 530 of FIG. 13 corresponds to a case where the predetermined period (display target period) is 1 month. The screen 530 includes a graph 531. The graph 531 includes a plurality of bars indicating the consumption per certain period (1 month). In each of the bars, the consumption of the direct current power and the consumption of the alternating current power in the certain period are indicated in mutually different forms (types of hatching).

### 10. Summary of Embodiment

In the first embodiment described above, a load device that is operated by switching the power for driving between the alternating current power and the direct current power is constituted by each of the household electric appliances 14 to 17. As described mainly with reference to FIG. 10, for the household electric appliance that is specified as the display target among the household electric appliances 14 to 17, the communication terminal 100 generates image data for display (display information) that is related to information about the consumption of the direct current power.

A length of the display target period may be specified from a plurality of types. In the first embodiment, the length may be specified from, for example, three types of 1 year, 1 month, and 1 day. Note that, the three types of periods indicated here are merely illustrative. The communication terminal 100 may receive, from the user, information for specifying any length as the display target period.

In the first embodiment, the communication terminal 100 sets “1 month” as the display target in some cases (refer to FIG. 2) and sets “1 day” as the display target in other cases (refer to FIG. 12). When setting “1 day” as the display target, the communication terminal 100 displays the consumption per 15 minutes. In each of 15-minute periods, when the direct current power has been used for a certain period (for example, 5 minutes) or more in the 15-minute period, the period is indicated in such a manner that the direct current power has been used for the full 15 minutes.

Note that, in the display per 15 minutes, when the consumption of the direct current power occupies a certain proportion (for example, 30%) or more with respect to the consumption of the power in the 15-minute period, the period may be indicated in such a manner that the power consumption for 15 minutes is all the power consumption of the direct current power. That is, the display per 15 minutes may be performed by deforming a type of the power that is consumed.

When the display target period is “1 month” (FIG. 2), the image data for display includes data (a bar representing the consumption of each day in the graph 511) indicating the daily consumption. In this sense, data for displaying the bar which represents the consumption of each day in the graph 511 is an example of “first display information”. The consumption of each day indicates the consumption of the direct current power of the day and the consumption of the alternating current power of the day.

When the display target period is “1 day” (FIG. 12), the image data for display includes data which indicates the consumption of the power per 15 minutes when 1 day as the display target is divided into each 15 minutes. In this sense, data of the graph 521 is an example of “second display information”.

### 11. Effect of Embodiment

It may be said that consuming the direct current power supplied from the direct current power source 12 or 13 in the power management system 1 of the first embodiment described above brings the following advantage for the user with respect to consuming the direct current power supplied from the commercial alternating current power source 11.

That is, the direct current power source 12 that supplies the direct current power to a household electric appliance provides the user with power converted from a solar energy instead of the power purchased from the commercial alternating current power source 11. Thereby, by using the power supplied from the direct current power source 12, the user does not need to pay the power cost to a power company.

The direct current power source 13 stores the power supplied from the direct current power source 12 and the power supplied from the commercial alternating current power source 11 at low cost, for example, at night. This makes it possible to reduce the power cost that the user pays to the power company by using the power supplied from the direct current power source 13.

It is also possible to enhance use efficiency of the power by operating an appliance with the direct current power without converting the direct current power supplied from the direct current power source 12 or 13 into the alternating current power. When the appliance is operated with the alternating current power, the alternating current power obtained by converting the direct current power supplied from the direct current power source 12 or 13 is used, so that a loss is caused due to the power conversion from the direct current power to the alternating current power. When the appliance is operated directly with the direct current power without converting the direct current power supplied from the direct current power source 12 or 13 into the alternating current power, there is no loss due to the conversion, thus making it possible to reduce the power consumption. As a result, operating the appliance with the direct current power exhibits an effect of reduction in the power consumption, and by displaying an amount of the power consumption, the effect of the reduction in the power consumption is able to be easily recognized. In other words, consuming the direct current power instead of the alternating current power brings high use efficiency of the power and reduction in the power consumption. Therefore, by performing display that the direct current power is consumed, it is possible to recognize that the effect of reduction in the power consumption is achieved.

In the first embodiment, the communication terminal 100 displays a screen such as the screen 510 of FIG. 2 by execution of the power management application of the power management system including household electric appliances. For example, in the graph 511 of the screen 510 of FIG. 2, information about the consumption of the direct current power supplied from the direct current power source 12 or 13 for a household electric appliance is displayed. Thereby, the user acquires the information about the consumption of the direct current power supplied from the direct current power source 12 or 13 and is thus able to easily recognize an effect of reduction in the consumption of the alternating current power.

### Second Embodiment

A hardware configuration of the power management system 1 of a second embodiment may be the same as that of the first embodiment. Note that, in comparison with the first embodiment, the control of step S50 of FIG. 10 is omitted in the communication terminal 100 in the power management system 1 of the second embodiment. That is, in the second embodiment, only information about the consumption of the direct current power for a household electric appliance serving as a display target is displayed.

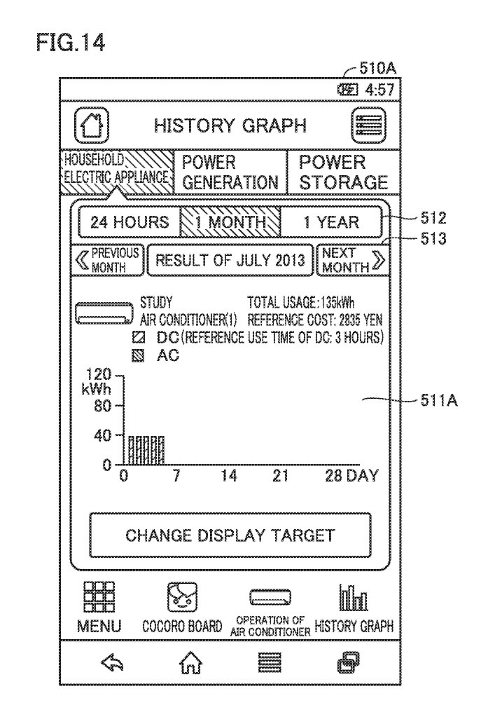

FIG. 14 illustrates an example of display related to power consumption of a household electric appliance in the second embodiment. A screen 510A of FIG. 14 corresponds to a modified example of the screen 510 of FIG. 2. A graph 511A is displayed on the screen 510A of FIG. 14. The graph 511A indicates the consumption of only the direct current power of the household electric appliance in a target period.

### Third Embodiment

A hardware configuration of the power management system 1 of a third embodiment may be the same as that of the first embodiment. In the third embodiment, however, the communication terminal 100 receives an input of a target value related to the consumption of the direct current power. In display of information about the consumption of the household electric appliance as illustrated in FIG. 2 or the like, the communication terminal 100 displays whether or not the consumption of the direct current power achieves the target value, that is, whether or not the consumption reaches the target value or more.

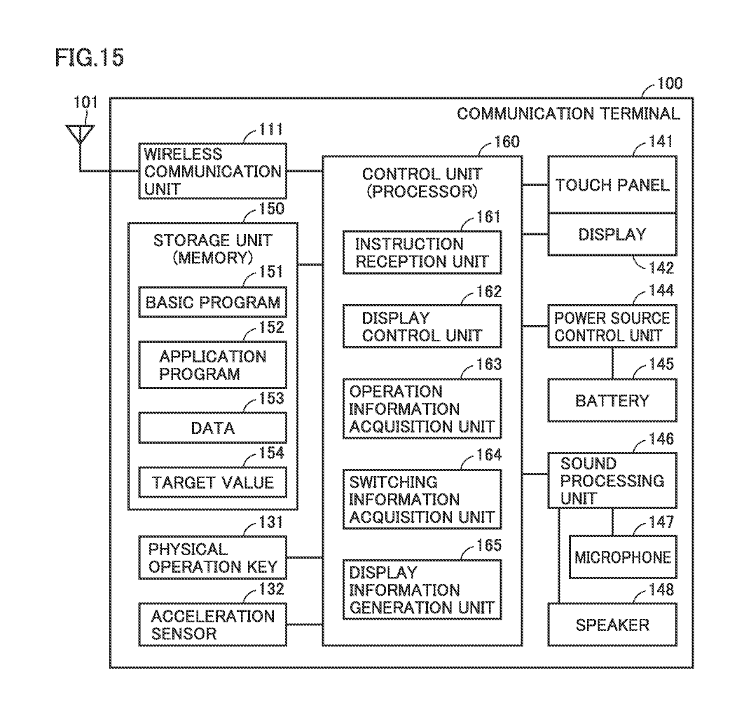

FIG. 15 is a block diagram illustrating a configuration of the communication terminal 100 in the power management system 1 of the third embodiment. As illustrated in FIG. 15, the communication terminal 100 of the third embodiment stores a target value 154 in the storage unit 150, in comparison with the communication terminal 100 (refer to FIG. 9) of the first embodiment. The target value 154 is, for example, a target value for the consumption of the direct current power for 1 month for a specific household electric appliance of the household electric appliances 14 to 17 (refer to FIG. 1) or for all the household electric appliances of the power management system 1. The user inputs the target value, for example, by operating the touch panel 141. In response thereto, the instruction reception unit 161 stores the input target value in the storage unit 150.

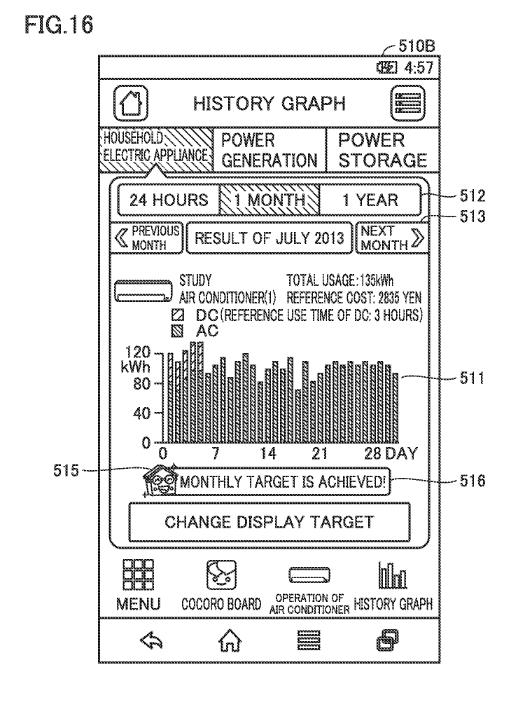

FIG. 16 illustrates an example of display of information about power consumption of a household electric appliance in the communication terminal 100 of the third embodiment. A screen 510B of FIG. 16 corresponds to a modified example of the screen 510 of FIG. 2. On the screen 510B of FIG. 16, an icon 515 and a message 516 are displayed with the graph 511. The screen 510B is displayed when the target value is achieved. Thus, the message 516 includes a character string (“Monthly target is achieved!”) indicating that the target value is achieved. The icon 515 includes an image indicating delight with achievement of the target value.

Note that, when the target value is not achieved, a screen different from the screen 510B is displayed on the display 142. Such a screen indicates that the target value is not achieved in place of the message 516 and includes a message for encouraging to achieve the target value in a next period (for example, next month).

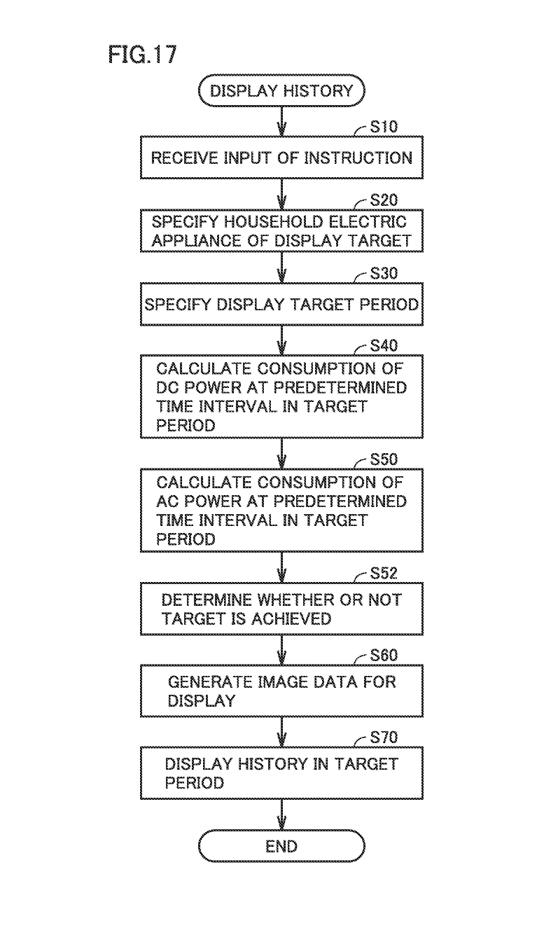

FIG. 17 is a flowchart of processing executed in the communication terminal 100 of the third embodiment. The processing of FIG. 17 corresponds to a modified example of the processing of FIG. 10 in the first embodiment. More specifically, the processing of FIG. 17 includes step S52 that is provided after step S50. In the third embodiment, the control is caused to proceed to step S52 after step S50.

At step S52, the control unit 160 determines whether or not the consumption (calculated at step S30) of the direct current power of the household electric appliance of the display target in the display target period is equal to or greater than the target value 154 stored in the storage unit 150 to thereby determine whether or not the target value is achieved. Then, the control is caused to proceed to step S60.

At step S60, the control unit 160 generates image data for display in a similar manner to the first embodiment. The image data generated in the third embodiment includes data, such as the icon 515 or the message 516 of FIG. 16, for displaying a result of determination about whether or not the target value is achieved.

Note that, an input of the “target value” in the present specification may be generated and stored in the storage unit 150 by an aspect other than an operation by the user, for example, by an output of an execution result of a different application. When the target value of the consumption of the direct current power for the household electric appliance is calculated, for example, as the result of execution of the different application, the control unit 160 may store the target value in the storage unit 150.

In another example, the target value may be the “reference cost” that is referred to in association with the screen 510 of FIG. 2. By dividing the “reference cost” that is registered as a target value by a predefined unit cost for purchasing the alternating current power, the control unit 160 is able to convert the target value of the “reference cost” into a target value of the consumption of the direct current power.

In still another example, the target value may be a target value of the consumption of the alternating current power. In this case, when the consumption of the alternating current power is equal to or smaller than the target value, it is determined that the target value is achieved. Thereby, the user may be notified that the consumption of the alternating current power is reduced due to an increase in the consumption of the direct current power.

### Fourth Embodiment

A hardware configuration of the power management system 1 of a fourth embodiment may be the same as that of the third embodiment. In the fourth embodiment, the control unit 160 of the communication terminal 100 further receives an input of information for changing the target value stored in the storage unit 150.

In the fourth embodiment, the target value for the consumption of the direct current power of a household electric appliance is stored in the storage unit 150 in association with a time at which the target value is stored in the storage unit 150 (or a time at which the target value is input). In the fourth embodiment, similarly to the third embodiment, the control unit 160 determines whether or not the consumption of the direct current power in the display target period is equal to or greater than the target value. Note that, in the fourth embodiment, the target value used for the determination is a target value stored being associated with a time before the display target period expires. A target value registered after the display target period expires is not used.

That is, for example, when information of the consumption of the direct current power for 1 month is displayed and when the display target period is changed in the course of the month, image data for display of the month is generated on the basis of the target value before the change. More specifically, when information of the power consumption of July is displayed and when the target value is changed on July 15, whether or not the target value of the power consumption of July is achieved is determined on the basis of the target value before the change.

### Fifth Embodiment

In the power management system 1 of a fifth embodiment, image data for display, such as the screen 510 of FIG. 2, related to the power consumption of a household electric appliance is generated in the HEMS controller 10. That is, in the fifth embodiment, the HEMS controller 10 is an example of the power information management device. Upon reception of an instruction to display the power consumption, the communication terminal 100 requests the HEMS controller 10 to generate image data for display.

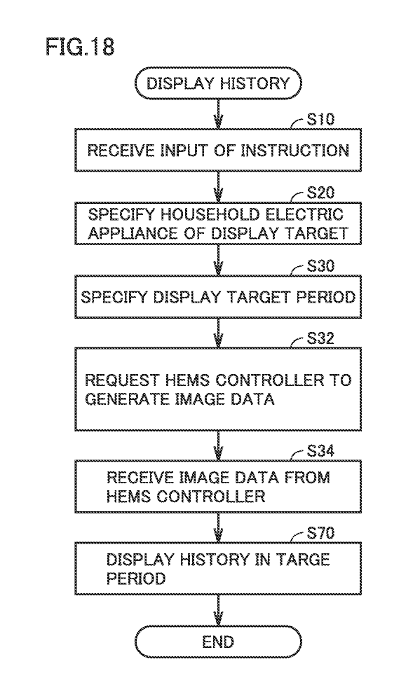

FIG. 18 is a flowchart of processing executed by the communication terminal 100 in the fifth embodiment.

As illustrated in FIG. 18, the control unit 160 receives an input for giving an instruction to present information about the power consumption of a household electric appliance (step S10), specifies a household electric appliance of a display target (step S20), and specifies a display target period (step S30). Then, the control is caused to proceed to step S32.

At step S32, the control unit 160 requests the HEMS controller 10 to generate image data for display. To the HEMS controller 10, the control unit 160 transmits, with the request, information of the household electric appliance specified at step S20 and information indicating the period specified at step S30.

In accordance with the request, the HEMS controller 10 generates image data for display as described below and transmits the resultant to the communication terminal 100. In response thereto, the control unit 160 receives the image data for display at step S34. Then, the control unit 160 displays the received image data (displays a history of the target period) at step S70.

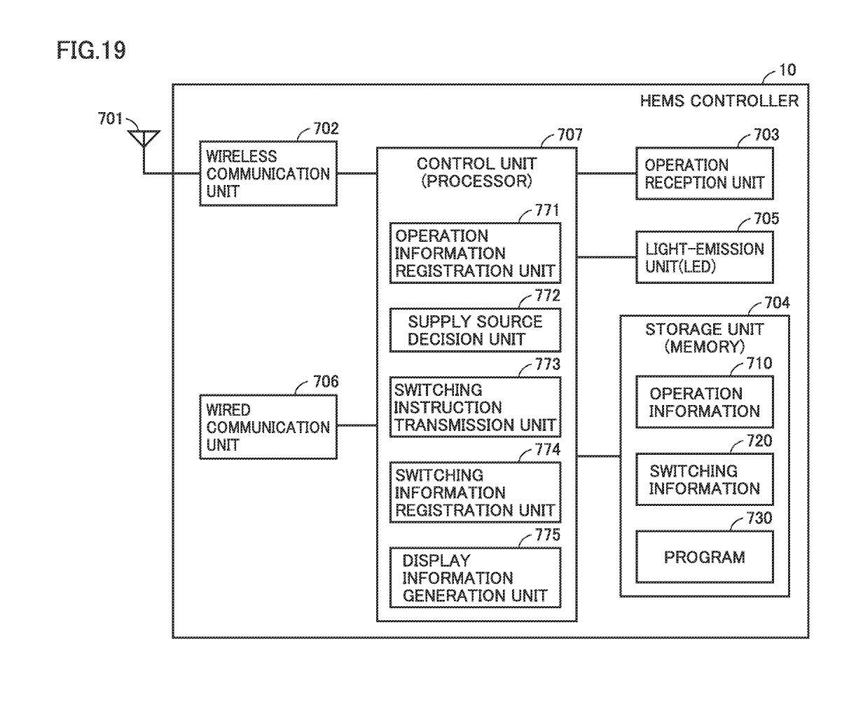

FIG. 19 is a block diagram illustrating a configuration of the HEMS controller 10 of the fifth embodiment. The block diagram of FIG. 19 corresponds to a modified example of the block diagram of FIG. 3. In comparison with FIG. 3, a control unit 707 of the HEMS controller 10 further implements a function as a display information generation unit 775 as illustrated in FIG. 19.

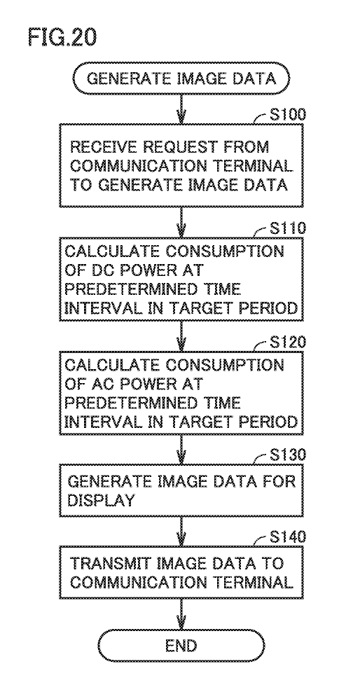

FIG. 20 is a flowchart of processing executed by the control unit 707 of the HEMS controller 10 of the fifth embodiment.

With reference to FIG. 20, at step S100, the control unit 707 receives the request (step S32 of FIG. 18) from the communication terminal 100 to generate image data. Then, the control is caused to proceed to step S110.

At step S110, similarly to step S40 (refer to FIG. 10), the control unit 707 calculates the consumption of the direct current power (DC power) of the household electric appliance of the display target in the target period. Then, the control is caused to proceed to step S120.

At step S120, similarly to step S50 (refer to FIG. 10), the control unit 707 calculates the consumption of the alternating current power (AC power) of the household electric appliance of the display target in the target period. Then, the control is caused to proceed to step S130.

At step S130, similarly to step S60 (refer to FIG. 10), the control unit 707 generates image data for display. Then, the control is caused to proceed to step S140.

At step S140, the control unit 707 transmits the image data generated at step S130 to the communication terminal 100. The control unit 160 of the communication terminal 100 receives the image data at step S34 (refer to FIG. 18).

In the fifth embodiment described above, even when an instruction to display information about the power consumption is given, the communication terminal 100 does not need to generate image data. The image data is generated by the HEMS controller 10. This results in reduction in processing load of a processor that constitutes the control unit 160 of the communication terminal 100.

### Sixth Embodiment

As a sixth embodiment, a modified example of a management mode of operation information and switching information in the power management system 1 is indicated. While operation information and switching information are individually managed in the first embodiment, information corresponding to the operation information and the switching information is managed as “power consumption information” in the sixth embodiment.

### 1. Specific Example of Power Consumption Information

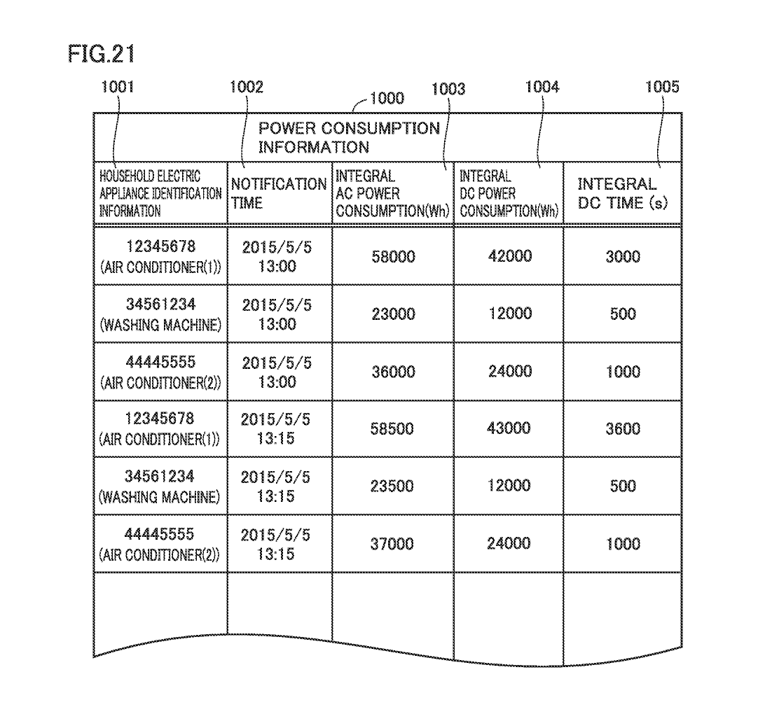

FIG. 21 schematically illustrates an example of content of the power consumption information.

As illustrated in FIG. 21, each of records in power consumption information 1000 includes household electric appliance identification information 1001, a notification time 1002, integral AC power consumption 1003, integral DC power consumption 1004, and an integral DC time 1005.

The household electric appliance identification information 1001 is information for specifying each of household electric appliances.

The notification time 1002 indicates a time at which the “state notification” (refer to FIG. 5) is received from each of the household electric appliances. That is, the HEMS controller 10 acquires each of the records in the power consumption information 1000, for example, through the “state notification” from each of the household electric appliances 14 to 17, which has been described with reference to FIG. 5. The notification time 1002 is a time at which the “state notification” is received.

The integral AC power consumption 1003 is an integral value of the consumption of the alternating current power in each of the household electric appliances transmitting the “state notification”. Each of the household electric appliances records an integral value of the consumption of the alternating current power in the household electric appliance and transmits the integral value to the HEMS controller 10 as the integral AC power consumption.

The integral DC power consumption 1004 is an integral value of the consumption of the direct current power in each of the household electric appliances transmitting the “state notification”. Each of the household electric appliances records an integral value of the consumption of the direct current power in the household electric appliance and transmits the integral value to the HEMS controller 10 as the integral DC power consumption.

The integral DC time 1005 is an integral value of a time during which the direct current power is consumed in each of the household electric appliances transmitting the “state notification”. Each of the household electric appliances records an integral value of a time during which the household electric appliance is driven with the direct current power and transmits the integral value to the HEMS controller 10 as the integral DC time.

### 2. Configuration of HEMS Controller

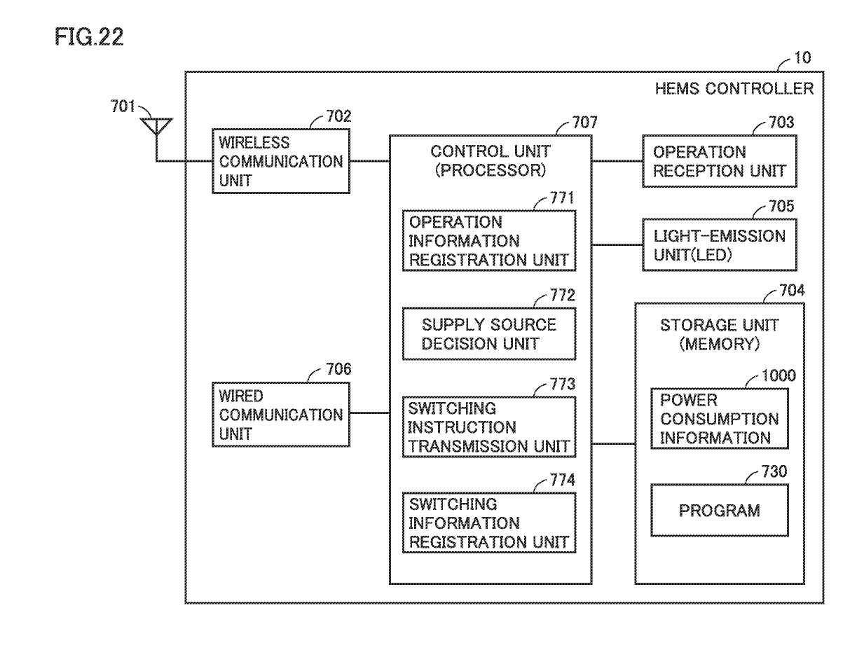

FIG. 22 illustrates a configuration of the HEMS controller 10 of the sixth embodiment.

The HEMS controller 10 illustrated in FIG. 22 is different from the HEMS controller 10 of the first embodiment illustrated in FIG. 3 in terms of information stored in the storage unit 704. Specifically, in the sixth embodiment, the storage unit 704 stores the power consumption information 1000 (refer to FIG. 21) instead of storing the operation information 710 and the switching information 720 of FIG. 3.

### 3. Specific Example of Communication Device

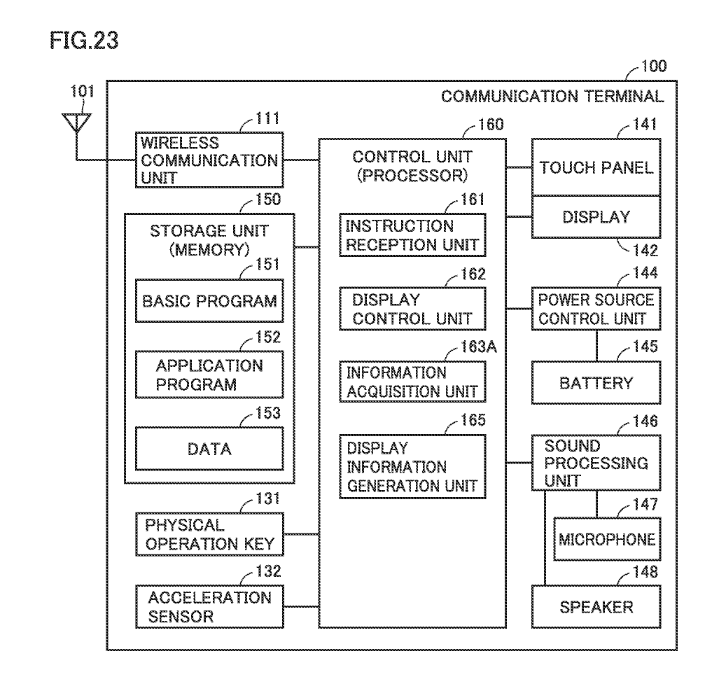

FIG. 23 is a block diagram illustrating a configuration of the communication terminal 100 of the sixth embodiment.

The communication terminal 100 illustrated in FIG. 23 is different from the communication terminal 100 of the first embodiment illustrated in FIG. 9 in terms of a function of the control unit 160. More specifically, the control unit 160 of the control unit 100 of the sixth embodiment implements a function as an information acquisition unit 163A instead of the functions as the operation information acquisition unit 163 and the switching information acquisition unit 164.

The information acquisition unit 163A is realized by the power management application installed on the communication terminal 100. The information acquisition unit 163A acquires, from the HEMS controller 10, for example, information of a household electric appliance of a display target for information about the consumption of the direct current power.

More specifically, the information acquisition unit 163A acquires, from the power consumption information (refer to FIG. 21), a record of the household electric appliance of the display target in a display target period. The information acquisition unit 163A calculates a difference between an integral value of the consumption of the direct current power for the household electric appliance when the display target period ends and an integral value of the consumption thereof when the period starts and thereby calculates the consumption of the direct current power in the display target period.

For example, according to the power consumption information illustrated in FIG. 21, the consumption of the direct current power for the household electric appliance specified by “air conditioner (1)” for fifteen minutes from 13:00 to 13:15 on May 5, 2015 is calculated as 1000 Wh from the following expression (1).

43000(Wh)−42000(Wh)=1000(Wh) (1)

In the expression (1), “43000 (Wh)” is the integral DC power consumption of the “air conditioner (1)” at 13:15 on May 5, 2015. “42000 (Wh)” is the integral DC power consumption of the “air conditioner (1)” at 13:00 on May 5, 2015.

### Seventh Embodiment

A power management system of a seventh embodiment includes a plurality of household electric appliances. The plurality of household electric appliances include a household electric appliance that uses the alternating current power as a power source and a household electric appliance that uses the direct current power as a power source. The plurality of household electric appliances may include one that uses only the alternating current power as a driving source, one that uses the direct current power as a driving source, and one that uses both the alternating current power and the direct current power as a driving source. That is, the power management system of the seventh embodiment includes a plurality of household electric appliances that are operated with the alternating current power and the direct current power.

In the seventh embodiment, a power information management device acquires, for the plurality of household electric appliances, information for specifying the consumption of the direct current power and information for specifying the consumption of the alternating current power. Display information generated by the power information management device indicates, for the plurality of household electric appliances, the consumption of the direct current power altogether and the consumption of the alternating current power altogether. Note that, in the seventh embodiment, the consumption of the direct current power and the consumption of the alternating current power for the plurality of household electric appliances are displayed in different forms.

It is to be understood that the disclosed embodiments and modified examples thereof are only illustrative and not restrictive in all aspects. The scope of the disclosure is interpreted by the scope of the claims rather than the foregoing description, and it is intended that all kinds of variations are included in a meaning and a range equivalent to the claims.

A program executed in each of the embodiments described above may be stored in a storage device that is fixed to a hardware resource such as the HEMS controller 10 or the communication terminal 100 or may be stored in a recording medium that is attachable to or detachable from the hardware resource. The program may be executed by being downloaded on the hardware resource via a network or by a processor provided in each hardware resource in a state of being stored in a storage device, such as a server, on the network.

### REFERENCE SIGNS LIST

10 HEMS controller
11 alternating current power source
12, 13 direct current power source
14 to 17 household electric appliance
100 communication terminal
160, 707, 900 control unit

1. A power information management device that acquires information about power consumption of a load device that is operated by using alternating current power by alternating current power supply and direct current power by direct current power supply as power, and
generates display information about power consumption of the direct current power of the load device.

2. The power information management device according to claim 1, wherein
the display information includes display information about the power consumption of the alternating current power of the load device, and includes information for displaying information about power consumption of the alternating current power of the load device and the information about the power consumption of the direct current power of the load device in mutually different forms.

3. The power information management device according to claim 1, wherein
the display information includes
first display information about the power consumption of the direct current power of the load device in a first period, and
second display information about the power consumption of the direct current power of the load device in each of second periods when the first period is divided into each of the second periods,
the first display information is display information in which power consumption per first period is displayed distinctively in accordance with a proportion of the consumption of the direct current power and the consumption of the alternating current power, and
the second display information is display information in which, in each of the second periods, when the power consumption of the direct current power occupies a certain proportion or more with respect to the power consumption of the second period, the power consumption of the second period is all regarded as the power consumption of the direct current power.

4. The power information management device according to claim 1, wherein
operation time information indicating a time during which the load device is operated and switching information indicating, together with the time, with which of the alternating current power or the direct current power the load device is operated are acquired, and
in the operation time information, power consumption for a time during which the load device is operated with the direct current power in the switching information is specified as the power consumption of the direct current power of the load device.

5. A power information management system, comprising:
the power information management device according to claim 1;
a direct current power source; and
the load device.

6. A power information management method, comprising the steps of:
acquiring information about power consumption of a load device that is operated by using alternating current power by alternating current power supply and direct current power by direct current power supply as power and
generating display information about power consumption of the direct current power of the load device.

7. A power information management device that acquires information about power consumption of a plurality of load devices including a load device that is operated with alternating current power by alternating current power supply and a load device that is operated with direct current power by direct current power supply, and
generates display information for displaying information about power consumption of the alternating current power of the plurality of load devices and information about power consumption of the direct current power of the plurality of load devices in mutually different forms.

8. The power information management method according to claim 6, wherein
the display information includes display information about the power consumption of the alternating current power of the load device, and includes information for displaying information about power consumption of the alternating current power of the load device and the information about the power consumption of the direct current power of the load device in mutually different forms.

9. The power information management method according to claim 6, wherein
the display information includes
first display information about the power consumption of the direct current power of the load device in a first period, and
second display information about the power consumption of the direct current power of the load device in each of second periods when the first period is divided into each of the second periods,
the first display information is display information in which power consumption per first period is displayed distinctively in accordance with a proportion of the consumption of the direct current power and the consumption of the alternating current power, and
the second display information is display information in which, in each of the second periods, when the power consumption of the direct current power occupies a certain proportion or more with respect to the power consumption of the second period, the power consumption of the second period is all regarded as the power consumption of the direct current power.

10. The power information management method according to claim 6, further comprising the step of
acquiring operation time information indicating a time during which the load device is operated and switching information indicating, together with the time, with which of the alternating current power or the direct current power the load device is operated, and wherein
the step of acquiring the information about the power consumption includes specifying, in the operation time information, power consumption for a time during which the load device is operated with the direct current power in the switching information as the power consumption of the direct current power of the load device.
